(19) United States
(12) Patent Application Publication
(10) Pub. No.: US 2023/0143070 A1
(43) Pub. Date: May 11, 2023

(54) LEARNING DEVICE, LEARNING METHOD, AND COMPUTER-READABLE MEDIUM

(71) Applicant: NEC Corporation, Minato-ku, Tokyo (JP)

(72) Inventors: Takaya MIYAMOTO, Tokyo (JP); Hiroshi HASHIMOTO, Tokyo (JP)

(73) Assignee: NEC Corporation, Minato-ku, Tokyo (JP)

(21) Appl. No.: 17/619,723

(22) PCT Filed: Mar. 10, 2021
(86) PCT No.: PCT/JP2021/009687

§ 371 Date: Dec. 16, 2021

(51) Int. Cl. G06N 20/00

(52) U.S. Cl. CPC G06N 20/00

(57) ABSTRACT

A learning device (12) includes: an input unit (109) that inputs target data to be learned, class label information of the target data, and statistical property information of the target data; a feature amount extractor (110) that extracts a feature amount from the target data by using a parameter; a class classifier (111) that outputs a class classification inference result of the target data by statistical processing using the feature amount and a weight vector of each class; a loss calculation unit (112) that calculates a loss by using a loss function in which the class classification inference result and the class label information are taken as inputs; and a parameter correction unit (113) that corrects the weight vector of the class classifier (111) and the parameter of the feature amount extractor (110) in such a way as to reduce the loss, according to the statistical property information.

### TECHNICAL FIELD

The present disclosure relates to a learning device, a learning method, and a computer-readable medium.

### BACKGROUND ART

A pattern recognition device is known which extracts a feature (pattern) of target data by a feature amount extractor, and recognizes the data by using the extracted feature amount. For example, in object image recognition, a feature amount vector is extracted from an image in which a target object is projected, and a class to which the target object belongs is estimated by a linear classifier. In face authentication, a feature amount vector is extracted from a person face image, and recognition of the person himself/herself or another person is performed based on a distance of the feature amount vectors in a feature amount space.

In order to enable such recognition, statistical machine learning has been widely used in which a feature amount extractor is made to learn in such a way as to bring statistical properties of target data and a class label thereof closer by using previously collected supervised data with a correct answer class label (hereinafter referred to as learning data). In an example of the face authentication, different persons are each defined as different classes, and supervised learning of multi-class classification problems is performed.

In general, statistical machine learning has high recognition performance with respect to data having the same statistical property as the learning data, but the performance is degraded with respect to data having a different statistical property from the learning data. Images having different statistical properties are, for example, images in which information other than class label information is different, such as an image photographed by a visible light camera and an image photographed by a near infrared camera.

A reason why performance is lowered for the data having different statistical properties is that statistical distributions of feature amounts to be extracted in the feature amount space are different. The reason will be described in detail by using an upper diagram of FIG. 1.

The upper diagram of FIG. 1 is a conceptual diagram relating to a distribution, in the feature amount space, of feature amounts for the data having different statistical properties. Herein, it is assumed that only two classes exist in the data, and then a feature amount of data belonging to a first class is represented by a star, and a feature amount of data belonging to a second class is represented by a triangle. In addition, a feature amount distribution of data having a first statistical property is represented by a solid line, and a feature amount distribution of data having a second statistical property is represented by a dotted line. In particular, it is assumed that the first statistical property is a statistical property of the learning data, and a statistical property different from the learning data is the second statistical property.

By the supervised learning using the learning data, the feature amount extractor is made to learn in such a way that a degree of separation between classes of the feature amount distributions (a range of solid-line circles in the upper diagram of FIG. 1) with respect to the data having the first statistical property becomes high. In other words, the feature amount extractor is made to learn in such a way that a distance of the feature amounts within the same class is small and a distance of the feature amounts between different classes is large.

At this time, the feature amount distribution for the data having the second statistical property, which is a statistical property different from the learning data, has a distribution different from the feature amount distribution for the data having the first statistical property because the feature amount distribution is not sufficiently learned (or not at all). In particular, the feature amount distribution has a distribution in which a degree of separation between classes is lower than that of the feature amount distribution for the data having the first statistical property.

As a result, as compared with a feature amount for the data having the first statistical property, a feature amount for the data having the second statistical property has a larger distance of feature amounts within the same class or a smaller distance of feature amounts between different classes, and therefore, recognition performance of the class classification or the like is lowered. In particular, in a case of face authentication, even when the face is an image of the person himself/herself, a distance between feature amounts of images having different statistical properties becomes large, and the recognition performance deteriorates.

There are many situations in which such a difference in statistical property from the learning data occurs. For example, in the case of face authentication, although the learning data include many images captured by a readily available visible light camera, the number of images captured by a near-infrared camera, a far-infrared camera, or the like is generally small (or not included). For this reason, there is a problem that recognition accuracy in a near-infrared image photographed by the near-infrared camera is lowered as compared with a visible light image photographed by the visible light camera.

In order to correct the difference in the statistical property between the data as described above, a technique of learning a feature amount extractor in such a way that feature amount distributions of the data of the same class, which are different in statistical property, are brought close to each other is known.

A lower diagram of FIG. 1 is a diagram conceptually illustrating correction of differences in statistical properties between data. Feature amount distributions extracted by the feature amount extractor before correction have different distributions in the data having different statistical properties, as illustrated in the upper diagram. In contrast, in feature amount distributions after correction, the feature amount extractor is made to learn in such a way that the feature amount distributions of data having different statistical properties in the same class are brought closer to each other. Arrows in the diagram each indicate a direction of correction of the feature amount distribution in the feature amount space. A solid arrow indicates a direction of correction of the feature amount distribution for the data having the first statistical property, and a dotted arrow indicates a direction of correction of the feature amount distribution for the data having the second statistical property.

By means of this correction, the data of the same class, having the first and second statistical properties, come to have a certain distribution. In addition, the feature amount distribution after correction has a higher degree of separation between the classes of the feature amounts with respect to the data having the second statistical property than the feature amount distribution before correction.

In the feature amount distribution after correction, since the data having the first and second statistical properties come to have a certain distribution, a distance between the feature amounts of the data, of the same class, having different statistical properties becomes smaller, as compared with the feature amount distribution before correction. As a result, for example, in the case of face authentication, there is an effect that authentication accuracy between images having different statistical properties (e.g., an image captured by a visible light camera and an image captured by a near infrared camera) is improved.

Further, the feature amount distribution after correction has an effect of improving authentication accuracy for the data having the second statistical property by increasing a degree of separation between classes of feature amounts with respect to the data having the second statistical property, as compared to the feature amount distribution before correction.

As one of techniques of correcting the difference in the statistical properties between the data as described above, there are learning methods disclosed in Patent Literatures 1 and 2.

In the learning method according to Patent Literature 1, when training data and test data follow different probability distributions, a prediction model is made to learn by gradient boosting using an importance-weighted loss function in consideration of an importance which is a ratio of generation probabilities of the training data and the test data. Thus, a label of the test data is predicted with higher accuracy. In this manner, in the learning method according to Patent Literature 1, a difference in statistical properties between the training data and the test data having different probability distributions, i.e., between the training data and the test data having different statistical properties is corrected. When the prediction model is configured by a feature amount extractor such as a neural network, this correction is synonymous with learning the feature amount extractor in such a way as to bring a feature amount distribution for the training data and a feature amount distribution for the test data closer to each other.

The learning method according to Patent Literature 2 relates to a technique called Domain adaptation that corrects a deviation of statistical properties between data, and is characterized by having an effect of achieving semi-supervised learning using data without domain information, in addition to data with domain information. In this manner, in the learning method according to Patent Literature 2, a difference in statistical properties between the data with domain information and the data without domain information, i.e., between the data with domain information and the data without domain information, which have different statistical properties, is corrected. When a model is configured by a feature amount extractor such as a neural network, this correction is synonymous with learning the feature amount extractor in such a way as to bring the feature amount distributions for the data each having a different domain closer to each other.

### CITATION LIST

### Patent Literature

[Patent Literature 1] Japanese Unexamined Patent Application Publication No. 2010-092266
[Patent Literature 2] International Patent Publication No. WO2019/102962

### SUMMARY

### Technical Problem

An object of the present disclosure is to solve the problems in the related art.

### Solution to Problem

A learning device according to one aspect is a learning device that performs supervised learning of a class classification problem, and includes:

an input unit that inputs target data to be learned, class label information of the target data, and statistical property information of the target data;

a feature amount extractor that extracts a feature amount from the target data by using a parameter;

a class classifier that outputs a class classification inference result of the target data by statistical processing using the feature amount and a weight vector of each class;

a loss calculation unit that calculates a loss by using a loss function that takes the class classification inference result and the class label information as inputs; and

a parameter correction unit that corrects the weight vector of the class classifier and the parameter of the feature amount extractor in such a way that the loss is reduced, according to the statistical property information.

A learning method according to one aspect is a learning method by a learning device that performs supervised learning of a class classification problem, and includes:

inputting target data to be learned, class label information of the target data, and statistical property information of the target data;

extracting, by a feature amount extractor, a feature amount from the target data by using a parameter;

outputting, by a class classifier, a class classification inference result of the target data by statistical processing using the feature amount and a weight vector of each class;

calculating a loss by using a loss function that takes the class classification inference result and the class label information as inputs; and

correcting the weight vector of the class classifier and the parameter of the feature amount extractor in such a way that the loss is reduced, according to the statistical property information.

A non-transitory computer-readable medium according to one aspect stores a program causing a computer that performs supervised learning of a class classification problem to execute:

processing of inputting target data to be learned, class label information of the target data, and statistical property information of the target data;

processing of extracting, by a feature quantity extractor, a feature amount from the target data by using a parameter;

processing of outputting, by a class classifier, a class classification inference result of the target data by statistical processing using the feature amount and a weight vector of each class;

processing of calculating a loss by using a loss function that takes the class classification inference result and the class label information as inputs; and

processing of correcting the weight vector of the class classifier and the parameter of the feature amount extractor in such a way that the loss is reduced, according to the statistical property information.

### Advantageous Effects of Invention

According to the aspects described above, it is possible to improve recognition performance for data having one or more statistical properties different from learning data without degrading recognition performance for data having the same statistical property as the learning data.

### BRIEF DESCRIPTION OF DRAWINGS

FIG. 1 is a conceptual diagram relating to a distribution, in a feature amount space, of feature amounts for data having different statistical properties.

FIG. 2 is a block diagram illustrating an example of a configuration of a learning device according to a first example embodiment.

FIG. 3 is a flowchart illustrating an example of an operation of the learning device according to the first example embodiment.

FIG. 4 is a conceptual diagram relating to the distribution of feature amounts in the feature amount space, which is used for explaining an effect of the learning device according to the first example embodiment.

FIG. 5 is a block diagram illustrating an example of a configuration of a learning device according to a second example embodiment.

FIG. 6 is a block diagram illustrating an example of a configuration of a learning device according to a third example embodiment.

FIG. 7 is a block diagram illustrating an example of a configuration of a learning device according to a fourth example embodiment.

FIG. 8 is a block diagram illustrating an example of a configuration of a computer that achieves the learning devices according to the first, second, third, and fourth example embodiments.

### DESCRIPTION OF EMBODIMENTS

Before describing example embodiments of the present disclosure, the problems and object of the present disclosure will be described in detail.

As described above, in the learning methods according to Patent Literatures 1 and 2, data having two specific statistical properties are used, and the feature amount extractor is made to learn in such a way as to bring the feature amount distributions of the two data closer. Therefore, there is a problem that recognition performance of data having a third statistical property further different from the two statistical properties remains low.

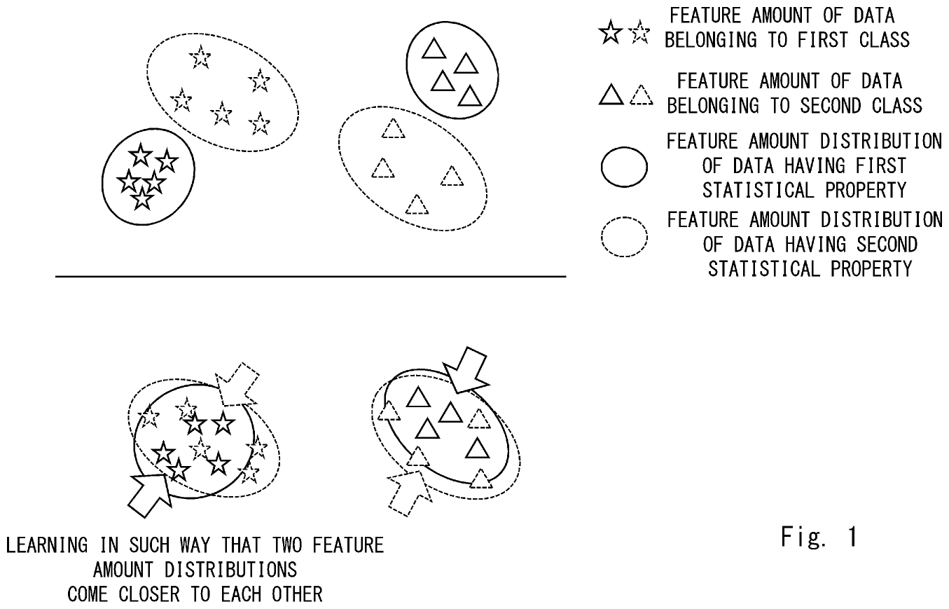

In addition, in the learning methods according to Patent Literatures 1 and 2, the feature amount extractor is made to learn in such a way that the feature amount distributions of data having two statistical properties are brought closer to each other. At this time, there is a problem that the recognition performance is improved in terms of data having a statistical property of the target (in FIG. 1, data having a second statistical property), but conversely, recognition performance is lowered in terms of data having the same statistical property as the original learning data (in FIG. 1, data having a first statistical property). For example, when a visible light image has the same statistical property as the learning data and a near infrared image has a statistical property different from the learning data, recognition performance for the near infrared image is improved, but recognition performance for the visible light image is lowered. This is because the feature amount distribution for the visible light image and the feature amount distribution for the near infrared image are brought close to each other, and therefore, the feature amount distribution for the visible light image, which originally has had a high degree of separation, is collapsed.

An object of the present disclosure is to improve recognition performance with respect to data having one or more statistical properties different from the learning data without collapsing the recognition performance with respect to data having the same statistical property as the learning data.

Hereinafter, example embodiments of the present disclosure will be described in detail with reference to the drawings.

It is noted that each diagram to be used in the following description is for explaining an example embodiment of the present disclosure. However, the present disclosure is not limited to the description of each diagram. In each diagram, the same or associated elements are denoted by the same reference numeral, and duplicate descriptions are omitted as necessary for clarity of description. In addition, in the diagrams to be used in the following description, the description of components not related to the description of the present disclosure is omitted and may not be illustrated.

Moreover, the data to be used by example embodiments of the present disclosure is not limited. A recognition target may be an image of an object or an image of a face. In the following description, an image of a face may be used as an example of data. However, this does not limit the target data.

### First Example Embodiment

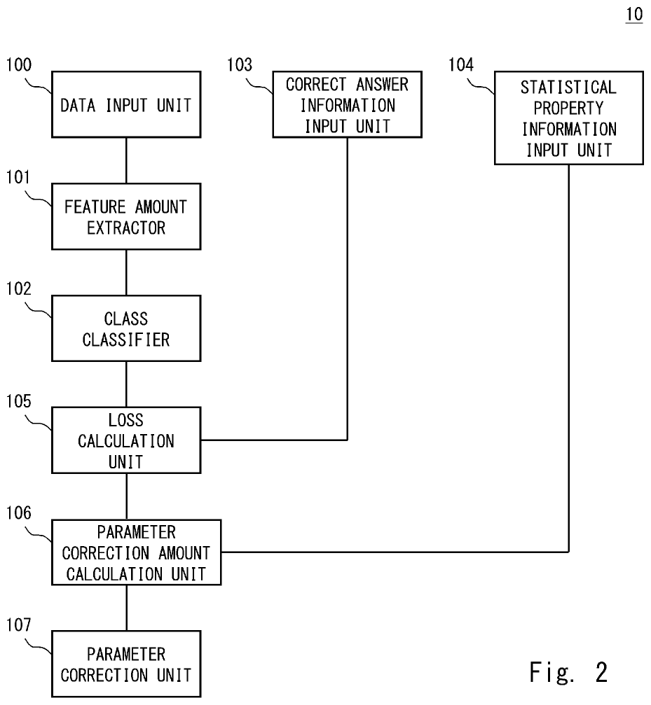

Hereinafter, a first example embodiment of the present disclosure will be described with reference to FIG. 2.

FIG. 2 is a block diagram illustrating an example of a configuration of a learning device 10 according to the first example embodiment. As illustrated in FIG. 2, the learning device 10 includes a data input unit 100, a feature amount extractor 101, a class classifier 102, a correct answer information input unit 103, a statistical property information input unit 104, a loss calculation unit 105, a parameter correction amount calculation unit 106, and a parameter correction unit 107.

The data input unit 100 inputs target data to be learned from the learning data. At this time, for example, when the target data are an image, the target data may be a normalized image in which a subject is normalized in advance based on the position of the subject included in the image. The input target data may be one or a plurality of pieces of data.

The feature amount extractor 101 includes learnable parameters, and calculates and outputs a feature amount representing features of the target data by using the parameters. Here, a specific form of the feature amount extractor 101 is not limited, and the feature amount extractor 101 may have a function of a convolution layer, a pooling layer, a fully coupled layer, or the like which is used in machine learning such as depth learning and included in a neural network such as a convolution neural network. A specific form of the parameter of the feature amount extractor 101 is, for example, a weight of a kernel (filter) in a case of the convolution layer, and a weight applied to the affine transformation in a case of the fully coupled layer. The feature amount being output from the feature amount extractor 101 may be in the form of a tensor (i.e., a feature amount map), or may be in the form of a vector (i.e., a feature amount vector).

The class classifier 102 outputs a class classification inference result of the target data by statistical processing using the feature amount being output from the feature amount extractor 101 and the weight vector of each class. However, when the feature amount being output from the feature amount extractor 101 is a tensor, the class classifier 102 performs statistical processing using the feature amount map and the weight vectors. The weight vectors may also be in the form of a tensor.

The weight vectors of each of classes, which are parameters of the class classifier 102, represent representative points, in the feature amount space, of each class, and the statistical processing of the weight vectors and the feature amounts represents calculation of a distance, in the feature amount space, of the feature amounts with respect to the representative points of each class. Therefore, the class classification inference result which is the output of the class classifier 102 is a value representing the distance between the feature amount being output from the feature amount extractor 101 and the representative point of each class. At this time, the number of weight vectors (i.e., the number of classes) does not need to coincide with the number of class labels being input to the correct answer information input unit 103 to be described later.

In the following description, the term “various parameters” refers to the parameters of the feature amount extractor 101 and the weight vectors of each of classes of the class classifier 102.

The correct answer information input unit 103 inputs class label information as correct answer information. The class label information is information representing a correct label of the target data. For example, when the target data are a face image, a person ID of a person moving in the face image may be used as a class label.

The statistical property information input unit 104 inputs statistical property information which is information representing the statistical property of the target data. The statistical property information may be a scalar value with a certain value, or a vector or tensor based on the statistical property. For example, when the target data are an image, the statistical property information may be set to 1 for an image photographed by a visible light camera, and the statistical property information may be set to 0 for an image photographed by an image sensor other than that.

The loss calculation unit 105 calculates and outputs a loss by using a loss function in which the class classification inference result being output from the class classifier 102 and the class label information being input to the correct answer information input unit 103 are taken as inputs (arguments). In addition, the loss calculation unit 105 simultaneously calculates a gradient of the loss function (i.e., the first derivative of the loss function) with respect to the various parameters for use in calculating a correction amount of the various parameters, which will be described later.

In the loss calculation unit 105, the loss calculated by using the loss function is defined to be a value according to a difference between the class classification inference result and the class label information. Specifically, the loss is defined in such a way as to have a larger value as the difference between the class classification inference result and the class label information, the larger the value is larger. Therefore, optimizing the various parameters in such a way as to reduce the loss is synonymous with optimizing in such a way as to bring the class classifying inference result closer to the correct answer label.

Herein, it can be said that bringing the class classification inference result closer to the correct answer label generally means that the distance between the feature amount and the weight vector of the same class is reduced and the distance between the feature amount and the weight vector of another class is increased in the feature amount space. In other words, optimizing the various parameters in such a way as to reduce the loss calculated by the loss calculation unit 105 is synonymous with optimizing in such a way as to reduce the distance between the feature amount and the weight vector of the same class and increase the distance between the feature amount and the weight vector of another class.

At this time, the specific functional form of the loss function to be used in the loss calculation unit 105 is not limited. For example, the loss function may be a Softmax-Cross Entropy Loss commonly used in class classification problems, or a margin system Softmax Loss such as SphereFace, CosFace, or ArcFace. The loss function may be a variety of loss functions used in distance learning, or a combination thereof.

The parameter correction amount calculation unit 106 calculates correction amounts of various parameters for reducing the loss calculated by the loss calculation unit 105. In particular, the parameter correction amount calculation unit 106 calculates the correction amount of each of various parameters according to the gradient of the loss function with respect to various parameters and the value of the statistical property information being input to the statistical property information input unit 104. Specifically, for example, as for the weight vector of the class classifier 102, the correction amount of the weight vector is calculated by statistical processing using the gradient of the loss function with respect to the weight vector and the value of the statistical property information. As for the parameters of the feature amount extractor 101, the gradient of the loss function with respect to the parameters of the feature amount extractor 101 may be used as the correction amount, or the correction amount of the parameter may be calculated by statistical processing using the gradient and the value of the statistical property information.

The parameter correction unit 107 corrects various parameters based on the correction amounts of the various parameters calculated by the parameter correction amount calculation unit 106. At this time, in order to correct various parameters, for example, a stochastic gradient descent method, an error back propagation method, or the like, which is used in machine learning such as depth learning, may be used.

As will be described later, the learning device 10 repeatedly corrects various parameters of the feature amount extractor 101 and the class classifier 102.

In the first example embodiment, the statistical property of the target data to be learned is not limited. The types of statistical properties of the target data being input to the statistical property information input unit 104 may be two or more.

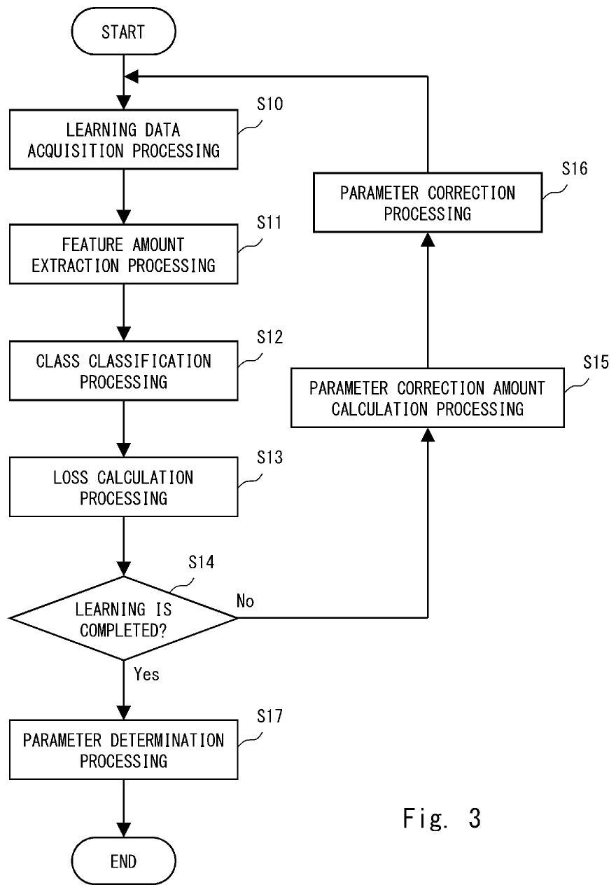

Next, an operation of the learning device 10 according to the first example embodiment will be described with reference to FIG. 3.

FIG. 3 is a flowchart illustrating an example of an operation of the learning device 10 according to the first example embodiment.

First, in S10, the data input unit 100 acquires a large amount of learning data from a learning database (not illustrated). As an example, the learning data may be a data set including an image serving as target data of a learning target, a correct answer label indicating a classification of a subject of the image, and statistical property information of the image. In this case, the data input unit 100 inputs the above-mentioned image as target data, the correct answer information input unit 103 inputs class level information representing the above-mentioned correct answer label, and the statistical property information input unit 104 inputs the above-mentioned statistical property information. Herein, the image of the target data may be a normalized image on which normalization processing has been performed in advance. When cross-validation is performed, the learning data may be classified into training data and test data.

Next, in S11, the feature amount extractor 101 calculates a feature amount acquired by extracting the feature of the target data being input to the data input unit 100 in the operation of S10, by using the parameter at that point in time.

The parameter at that point in time is a parameter after being corrected by the parameter correction unit 107 in a previous operation of S16. In the case of the first operation, the parameter at that point in time is an initial value of the parameter. The initial value of the parameter of the feature amount extractor 101 may be randomly determined or the one learned in advance by supervised learning may be used.

Next, in S12, the class classifier 102 outputs a class classification inference result of the target data by statistical processing using the feature amount calculated by the feature amount extractor 101 in the operation of S11 and the weight vector by using the weight vector at that point in time.

The weight vector at that point in time is a weight vector after being corrected by the parameter correction unit 107 in the previous operation of S16. In the case of the first operation, the weight vector at that point in time is an initial value of the weight vector. The initial value of the weight vector may be randomly determined, or the one learned in advance by supervised learning may be used.

Next, in S13, the loss calculation unit 105 calculates a loss between the class classification inference result being output by the class classifier 102 in the operation of S12 and the correct answer label being input to the correct answer information input unit 103 in the operation of S10, by using the loss function. The loss calculation unit 105 also calculates the gradient of the loss function with respect to various parameters at the same time.

Next, in S14, the parameter correction amount calculation unit 106 determines whether to complete the learning. In the first example embodiment, the parameter correction amount calculation unit 106 may determine whether to complete the learning by determining whether the number of updates representing the number of times of performing the operation of S16 has reached a preset number of times. The parameter correction amount calculation unit 106 may determine whether to complete the learning by determining whether the loss is less than a predetermined threshold value. When the learning is completed (Yes in S14), the parameter correction amount calculation unit 106 advances the processing to S17, and otherwise (No in S14), advances the processing to S15.

In S15, the parameter correction amount calculation unit 106 calculates correction amounts of various parameters for reducing the loss calculated by the loss calculation unit 105 in the operation of S13. For example, the parameter correction amount calculation unit 106 calculates the correction amount of each of the various parameters, based on the gradient of the loss function with respect to each of the various parameters, which is calculated by the loss calculation unit 105 in the operation of S13, and the value of the statistical property information, which is input to the statistical property information input unit 104 in the operation of S10. At this time, as for the parameter (weight vector) of the class classifier 102, the value acquired by performing statistical processing on the gradient of the loss function with respect to the weight vector based on the statistical property information is used as the correction amount. On the other hand, as for the parameters of the feature amount extractor 101, the gradient of the loss function with respect to the parameters of the feature amount extractor 101 may be used as the correction amount, or the correction amount may be calculated by statistical processing using the gradient and the value of the statistical property information.

In S16, the parameter correction unit 107 corrects various parameters based on the correction amounts of the various parameters calculated by the parameter correction amount calculation unit 106 in the operation of step S15. The parameter correction unit 107 may update various parameters by using, as an example, a stochastic gradient descent method and an error back propagation method. At this time, an order in which the parameters are corrected is not limited. In other words, the parameter correction unit 107 may correct the weight vector of the class classifier 102 after correcting the parameter of the feature amount extractor 101, or may perform correction in the reverse order. The parameter correction unit 107 may separate the correction of the parameter of the feature amount extractor 101 and the correction of the weight vector of the class classifier 102 for each iteration of learning. Then, the parameter correction unit 107 returns the processing to S10.

In S17, the parameter correction unit 107 determines various parameters to be the values corrected in the operation of the most recent step S16.

Thus, the operation of the learning device 10 is completed.

In this manner, the learning device 10 optimizes the parameters included in the feature amount extractor 101 and the weight vectors included in the class classifier 102 by machine learning.

Next, effects of the learning device 10 according to the first example embodiment will be described.

As described above, according to the first example embodiment, the parameter correction unit 107 corrects the parameter of the feature amount extractor 101 and the weight vector of the class classifier 102 in such a way that the loss calculated by the loss calculation unit 105 becomes small. This is synonymous with reducing the distance between the feature amount and the weight vector of the same class and increasing the distance between the feature amount and the weight vector of another class in the feature amount space.

Correcting the weight vector of the class classifier 102 in such a way as to reduce the loss means correcting the weight vector in a direction of the feature amount of the input target data. In other words, when the input target data are data having the first statistical property, the weight vector is corrected toward a direction of the feature amount distribution for the data having the first statistical property. When the input target data are data having the second statistical property, the weight vector is corrected toward a direction of the feature amount distribution for the data having the second statistical property.

Also, correcting the parameters of the feature amount extractor 101 in such a way as to reduce the loss means correcting the feature amount extracted by the feature amount extractor 101 in a direction of the weight vector of the same class and in a direction away from the weight vector of another class.

By repeating the correction of the parameters of the feature amount extractor 101 and the weight vector of the class classifier 102, the feature amount extractor 101 is made to learn in such a way that the feature amount distributions for data having different statistical properties come closer to each other.

According to the first example embodiment, the parameter correction amount calculation unit 106 changes the correction amount of the weight vector of the class classifier 102 according to the statistical property of the target data. Specifically, when data having a specific statistical property (e.g., an image captured by a visible light camera) are input, the weight vector is corrected, but when data having other statistical properties are input, the weight vector is not corrected (or the correction amount is reduced). As a result, the direction in which the weight vector is corrected becomes the direction of the feature amount distribution for the data having a specific statistical property.

As a result, instead of bringing the feature amount distributions for data having different statistical properties closer to each other, the feature amount extractor 101 is made to learn in such a way that the feature amount distributions for the data having other statistical properties come closer toward the feature amount distribution for the data having a specific statistical property (e.g., an image captured by a visible light camera). As a result, it is possible to improve the recognition performance with respect to the data having other statistical properties without degrading the recognition performance with respect to the data having a specific statistical property.

Further, according to the first example embodiment, the feature amount distribution for the data having another statistical property is brought closer toward the feature amount distribution for data having one specific statistical property. Therefore, the type of the data having other statistical properties is not limited to one, and the feature amount distributions for data having a plurality of types of statistical properties can be simultaneously optimized. This can improve the recognition performance with respect to data having one or more statistical properties different from a specific statistical property without degrading the recognition performance with respect to data having a specific statistical property.

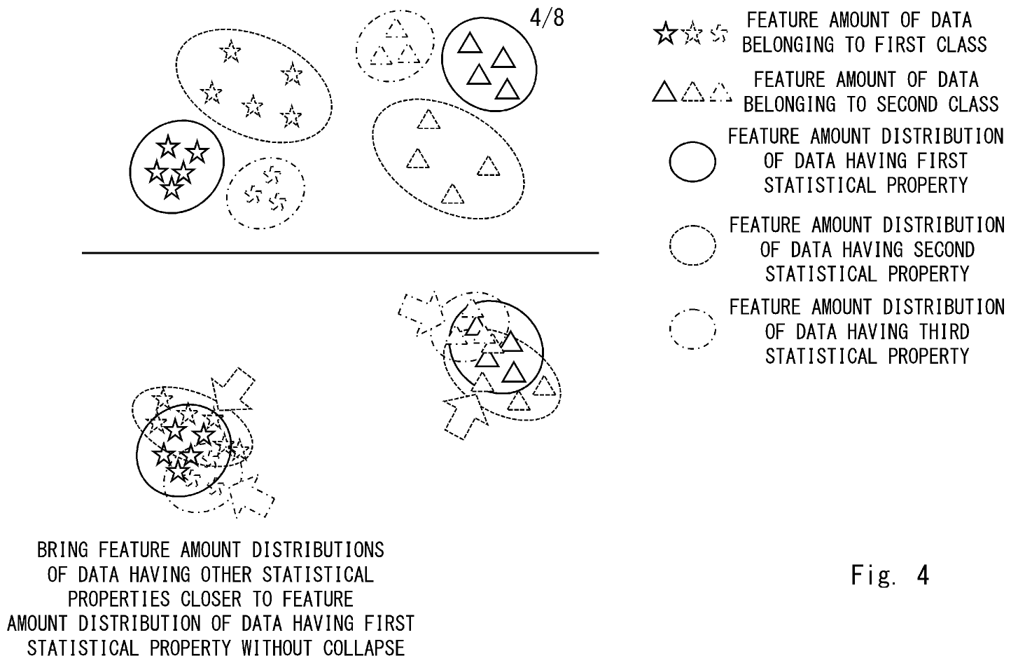

FIG. 4 is a conceptual diagram illustrating an effect of the learning device 10 according to the first example embodiment.

The upper diagram of FIG. 4 is a conceptual diagram relating to a distribution, in the feature amount space, of feature amounts for data having different statistical properties. Herein, it is assumed that only two classes exist in the data, and a feature amount of data belonging to the first class is represented by a star, and a feature amount of data belonging to the second class are represented by a triangle. In addition, a feature amount distribution of the data having the first statistical property is represented by a solid line, a feature amount distribution of the data having the second statistical property is represented by a dotted line, and a feature amount distribution of data having a third statistical property is represented by a dashed-dotted line. In particular, assuming that the first statistical property is a statistical property of the learning data, statistical properties different from the learning data are the second and third statistical properties.

FIG. 4 is a diagram conceptually illustrating correction of a difference in statistical properties between data according to the first example embodiment. The feature amount distributions extracted by the feature amount extractor 101 before correction include different distributions in the data having different statistical properties, as illustrated in the above diagram. On the other hand, according to the first example embodiment, the feature amount extractor 101 is made to learn in such a way that the feature amount distribution of the data having the first statistical property does not collapse and the feature amount distributions of the data having other statistical properties are brought closer to the feature amount distribution of the data having the first statistical property. Arrows in the diagram each indicate a direction of correction of the feature amount distribution in the feature amount space. An arrow in a dotted line represents a direction of correction of the feature amount distribution for the data having the second statistical property, and an arrow in a dashed line represents a direction of correction of the feature amount distribution for the data having the third statistical property.

Next, a specific example of the learning device 10 according to the first example embodiment will be described.

For example, in face matching, the data input unit 100 inputs a face image as target data to be learned from among the learning data. At this time, the input face image may be an image in which normalization processing has been performed in advance based on face organ points. In the following description, the input face image is denoted as I.

The feature amount extractor 101 extracts a feature of the input face image I and outputs a feature amount. Herein, the feature amount extractor 101 is denoted as F_{Φ}. It is noted that Φ is a parameter included in the feature amount extractor 101. When the feature amount being output from the feature amount extractor 101 is denoted as x, a series of processing performed by the feature amount extractor 101 can be expressed as x=F_{Φ}(I). In the following description, the feature amount x is assumed to be a vector, and is denoted as a feature amount vector x.

The class classifier 102 inputs the feature amount vector x, and outputs a class classification inference result of the input face image I by statistical processing using a weight vector of each class. Herein, the weight vector of each class is denoted as wᵢ. i is a subscript representing a class. It is assumed that the dimension of the feature amount vector x and the dimension of the weight vector are the same. Further, it is assumed that the feature amount vector x and the weight vector wᵢ are normalized to 1. When the class classification inference result is denoted as yᵢ and the inner product of the feature amount vector x and the weight vector wᵢ is used as an example of statistical processing, a series of processing performed by the class classifier 102 can be represented as yᵢ=wᵢ·x. At this time, the class classification inference result yᵢ is a scalar value having a value from −1 to 1, which represents that the distance between the feature amount vector x and the weight vector wᵢ in the feature amount space is closer when the value is larger.

The correct answer information input unit 103 inputs class label information (i.e., correct answer label) of the input face image I. Herein, the correct answer label is denoted as tᵢ, and tᵢ is a scalar value (i.e., one-hot vector) having a value of 1 only for a class to which the input-face image I belongs and a value of 0 for other classes. However, a specific form of tᵢ is not limited, and, for example, a Label-Smoothing may be performed in such a way that only the class to which the input face image I belongs has a value of 1 and the other classes have a certain small value.

The statistical property information input unit 104 inputs statistical property information of the input face image I. Herein, the statistical property information is denoted as P, and P is a scalar value having a value from 0 to 1. For example, when the input face image I is an image photographed by a visible light camera, P is set to 1, and when an image photographed by another image sensor is input, P is set to 0. However, P may have any value from 0 to 1 depending on the type of the image sensor.

The loss calculation unit 105 calculates a loss by using a loss function in which the class classification inference result yᵢ and the class label information tᵢ, which are outputs of the class classifier 102, are taken as inputs (arguments), and also calculates a gradient of the loss function with respect to various parameters. The loss function is assumed to be Softmax-Cross Entropy Loss and denoted as L. A specific form of L is L=−Σᵢ tᵢ log[S(yᵢ)] with S as Softmax functions. Further, the gradient of the loss function L with respect to the parameter Φ of the feature amount extractor 101 is ∂L/∂Φ, and the gradient of the loss function L with respect to the weight vector wᵢ of the class classifier 102 is ∂L/∂wᵢ.

The parameter correction amount calculation unit 106 calculates correction amounts of various parameters, based on the loss function L, its gradient, and statistical property information P. Herein, the correction amount of the parameter Φ of the feature amount extractor 101 is −λ_{Φ}∂L/∂Φ by using the gradient of the loss function L, and the correction amount of the weight vector wᵢ of the class classifier 102 is −Pλ_{w}∂L/∂w by using the gradient of the loss function L and the statistical property information P. Herein, λ_{Φ} and λ_{w} are each hyper parameters determining a learning rate of the parameter Φ and the weight vector w.

The parameter correction unit 107 corrects various parameters by the error back propagation method, based on the correction amounts of the various parameters calculated by the parameter correction amount calculation unit 106. At this time, the order in which the parameters are corrected is not limited. In other words, the parameter correction unit 107 may correct the weight vector wᵢ of the class classifier 102 after correcting the parameter Φ of the feature amount extractor 101, or may perform correction in the reverse order. The parameter correction unit 107 may separate the correction of the parameter Φ of the feature amount extractor 101 and the correction of the class classifier 102 for each iteration of learning.

In the above description, when the target data are an image, only one image is input, but a plurality of images may be input at a time in order to improve learning efficiency.

As described above, in this example embodiment, by multiplying the gradient of the loss function L with respect to the weight vector wᵢ of the class classifier 102 by the statistical property information P, the correction amount of the weight vector wᵢ of the class classifier 102 is determined according to the statistical property of the input face image I. P has a value of 1 for an image photographed by a visible light camera, and 0 for an image photographed by another image sensor. Therefore, the weight vector wᵢ is corrected only in the direction of the feature amount distribution with respect to the image photographed by the visible light camera. The parameter Φ of the feature amount extractor 101 is corrected in such a way that the feature amount vector comes closer to the weight vector wᵢ of the same class regardless of the statistical property information P of the input face image I. As a result, the feature amount extractor 101 is made to learn in such a way as to bring the feature amount distributions for the image photographed by another image sensor closer without collapsing the feature amount distribution for the image photographed by the visible light camera.

### Second Example Embodiment

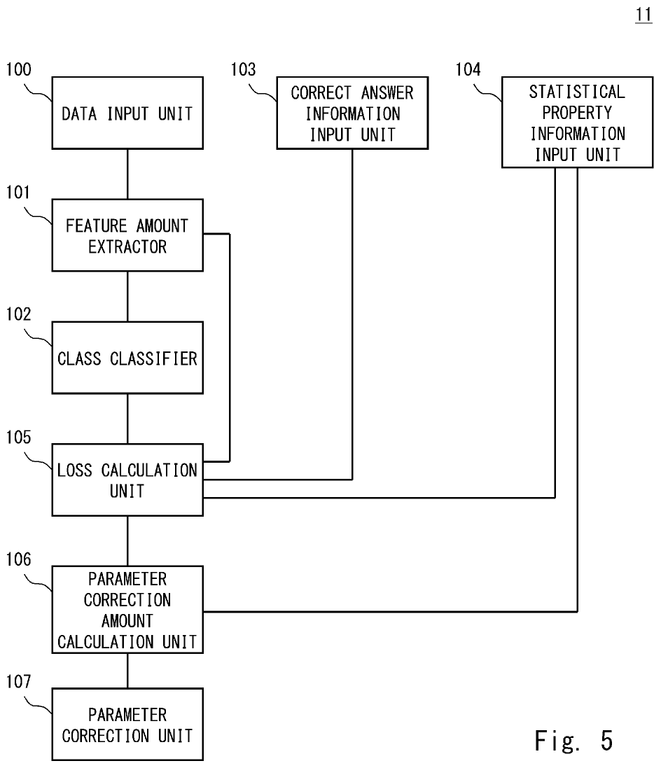

Next, a second example embodiment of the present disclosure will be described with reference to FIG. 5.

FIG. 5 is a block diagram illustrating an example of a configuration of a learning device 11 according to the second example embodiment. Hereinafter, description of the same configuration and functions as those of the learning device 10 according to the first example embodiment described above will be omitted, and differences will be described.

As illustrated in FIG. 5, the learning device 11 according to the second example embodiment is different from the learning device 10 according to the first example embodiment described above in that a loss calculation unit 105 is connected to a feature amount extractor 101 and a statistical property information input unit 104, and correct answer information being input to a correct answer information input unit 103.

The correct answer information input unit 103 inputs class label information or a correct answer vector as correct answer information. The correct answer vector is a desired feature amount vector for target data. The correct answer vector may be generated by an optional method. For example, the correct answer information input unit 103 may generate a feature amount vector for the target data by using a learned feature amount extractor (this feature amount extractor is prepared separately from the feature amount extractor 101) and use the feature amount vector as a correct answer vector.

Herein, the correct answer information input unit 103 inputs the class label information or the correct answer vector depending on whether the target data are data having a specific statistical property. In other words, when the target data are data having a specific statistical property, the correct answer information input unit 103 inputs a correct answer vector of the target data. When the target data are data having a statistical property other than the specific statistical property, the correct answer information input unit 103 inputs class label information of the target data.

The loss calculation unit 105 determines whether the target data are data having a statistical property, based on statistical property information being input to the statistical property information input unit 104. When the target data are data having a specific statistical property, the loss calculation unit 105 calculates a loss by using a loss function in which the correct answer vector being input to the correct answer information input unit 103 and the feature amount vector extracted by the feature amount extractor 101 are taken as inputs (arguments). When the target data are data having a statistical property other than the specific statistical property, the loss calculation unit 105 calculates a loss by using a loss function in which class classification inference result being output from the class classifier 102 and the class label information being input to the correct answer information input unit 103 are taken as inputs (arguments).

As described above, in the second example embodiment, when the target data are data having a specific statistical property, a distance between the feature amount vector and the correct answer vector is calculated as a loss, and various parameters are corrected in such a way that the loss becomes small. Therefore, it is possible to further improve the effect that a feature amount distribution of the data having a specific statistical property is not collapsed.

### Third Example Embodiment

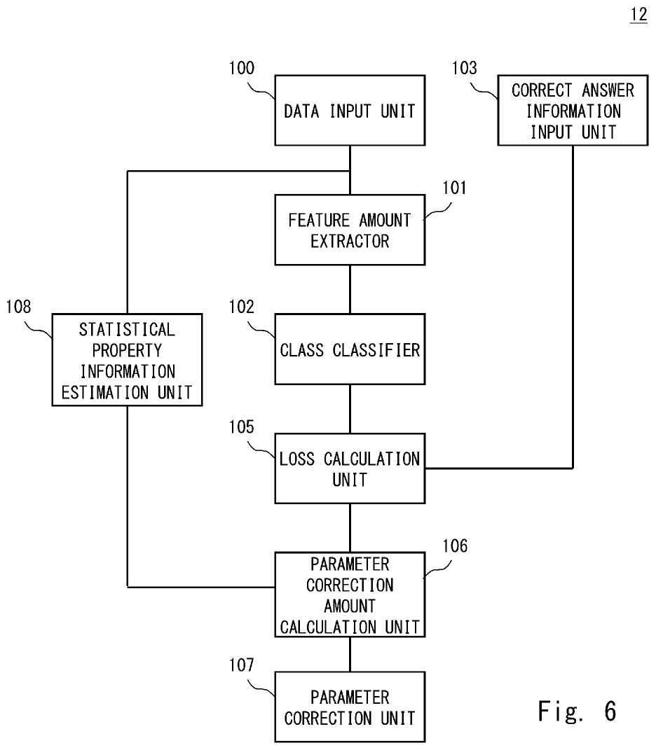

Next, a third example embodiment of the present disclosure will be described with reference to FIG. 6.

FIG. 6 is a block diagram illustrating an example of a configuration of a learning device 12 according to the third example embodiment. Hereinafter, description of the same configuration and functions as those of the learning device 10 according to the first example embodiment described above will be omitted, and differences will be described.

According to the learning device 10 according to the first example embodiment described above, statistical property information is necessary for all the target data to be learned, but there is a case where statistical property information cannot be acquired depending on the target data.

As illustrated in FIG. 6, the learning device 12 according to the third example embodiment is characterized in that a statistical property information estimation unit 108 is provided instead of the statistical property information input unit 104 according to the first example embodiment described above.

The statistical property information estimation unit 108 estimates statistical property information of the target data from the target data being input to a data input unit 100, and outputs the estimated statistical property information. The output statistical property information is used for calculating correction amounts of various parameters by a parameter correction amount calculation unit 106 in the same manner as in the first example embodiment described above.

Herein, the specific form of the statistical property information estimation unit 108 is not limited, and the statistical property information estimation unit 108 may have a function of a convolution layer, a pooling layer, a fully coupled layer, or the like, which is used in machine learning such as depth learning and included in a neural network such as a convolution neural network. The statistical property information estimation unit 108 may use a model being made to learn in advance in such a way that the statistical property of the target data can be estimated from the target data.

As described above, in the third example embodiment, the statistical property information estimation unit 108 estimates the statistical property information of the target data from the target data being input to the data input unit 100. Therefore, even when statistical property information is not added to the target data, the same effect as that of the first example embodiment can be acquired.

In the third example embodiment, the statistical property information is estimated for all the target data, but when the statistical property information is added to a part of the target data, the form of the first example embodiment described above may be adopted at a time of learning using the target data.

Specifically, in the third example embodiment, the statistical property information estimation unit 108 and the statistical property information input unit 104 according to the first example embodiment described above may be provided at the same time. In this case, when the statistical property information is input to the statistical property information input unit 104, the parameter correction amount calculation unit 106 may use the input statistical property information, and when there is no input of the statistical property information to the statistical property information input unit 104, may use the statistical property information estimated by the statistical property information estimation unit 108.

Although the third example embodiment has been described as a configuration including the statistical property information estimation unit 108 instead of the statistical property information input unit 104 according to the first example embodiment described above, the present example embodiment is not limited to this. The third example embodiment may be configured to include the statistical property information estimation unit 108 instead of the statistical property information input unit 104 according to the second example embodiment described above.

The third example embodiment can also include the statistical property information estimation unit 108 and the statistical property information input unit 104 according to the second example embodiment described above at the same time. In this case, a loss calculation unit 105 may determine statistical property information to be used in the same manner as the parameter correction amount calculation unit 106 described above.

### Fourth Example Embodiment

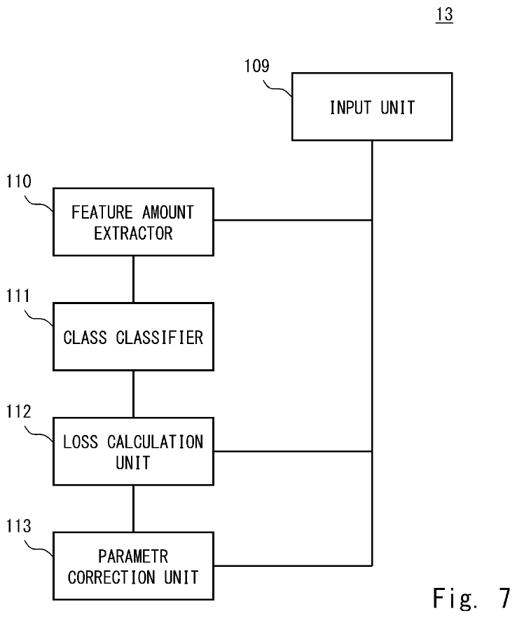

Next, a fourth example embodiment of the present disclosure will be described with reference to FIG. 7. The fourth example embodiment is equivalent to an example embodiment in which the first, second, and third example embodiments described above are conceptualized to a superordinate level.

FIG. 7 is a block diagram illustrating an example of a configuration of a learning device 13 according to the fourth example embodiment. As illustrated in FIG. 7, the learning device 13 includes an input unit 109, a feature amount extractor 110, a class classifier 111, a loss calculation unit 112, and a parameter correction unit 113.

The input unit 109 inputs target data to be learned, class label information representing a correct answer label of the target data, and statistical property information representing a statistical property of the target data. The input unit 109 is associated to the data input unit 100 and the correct answer information input unit 103 according to the first, second, and third example embodiments described above, and the statistical property information input unit 104 according to the first and second example embodiments described above.

The feature amount extractor 110 extracts a feature amount from the target data being input to the input unit 109 by using a parameter. The feature amount extractor 110 is associated to the feature amount extractor 101 according to the first, second, and third example embodiments described above.

The class classifier 111 outputs a class classification inference result of the target data being input to the input unit 109 by statistical processing using the feature amount calculated by the feature amount extractor 110 and a weight vector of each class. The class classifier 111 is associated to the class classifier 102 according to the first, second, and third example embodiments described above.

The loss calculation unit 112 calculates a loss by using a loss function in which the class classification inference result being output from the class classifier 111 and the class label information being input to the input unit 109 are taken as inputs (arguments). The loss calculation unit 112 is associated to the loss calculation unit 105 according to the first, second, and third example embodiments described above.

The parameter correction unit 113 corrects the weight vector of the class classifier 111 and the parameter of the feature amount extractor 110 in such a way that the loss calculated by the loss calculation unit 112 is reduced according to the statistical property information being input to the input unit 109. The parameter correction unit 113 is associated to the parameter correction unit 107 according to the first, second, and third example embodiments described above.

As described above, according to the fourth example embodiment, the parameter correction unit 113 corrects the weight vector of the class classifier 111 and the parameter of the feature amount extractor 110 in such a way that the loss is reduced. Therefore, the feature amount extractor 110 is made to learn in such a way that the feature amount distributions for data having different statistical properties come closer.

The parameter correction unit 113 corrects the weight vector of the class classifier 111 according to the statistical property information of the target data. Therefore, instead of bringing the feature amount distributions for data having different statistical properties closer to each other, the feature amount extractor 110 is made to learn in such a way that a feature amount distribution for data having another statistical property comes closer toward the feature amount distribution for data having a specific statistical property.

In addition, since the feature amount distribution for data having another statistical property is brought closer toward the feature amount distribution for data having a specific statistical property, a type of data having another statistical property is not limited to one, and may be plural.

As a result, according to the fourth example embodiment, it is possible to improve recognition performance for data having one or more statistical properties different from a specific statistical property without degrading recognition performance for data having the specific statistical property.

The learning device 12 may further include a parameter correction amount calculation unit that calculates a correction amount of the weight vector of the class classifier 111 and a correction amount of the parameter of the feature amount extractor 110 in such a way that the loss is reduced according to the statistical property information. The parameter correction amount calculation unit is associated to the parameter correction amount calculation unit 106 according to the first, second, and third example embodiments described above. The parameter correction unit 113 may correct the weight vector of the class classifier 111 and the parameter of the feature amount extractor 110 by using the correction amount calculated by the parameter correction amount calculation unit.

The input unit 109 may input a correct answer vector of the target data when the target data are data having a specific statistical property, and may input the class label information of the target data when the target data are data having a statistical property other than the specific statistical property. Further, the feature amount extractor 110 may extract a feature amount vector as a feature amount from the target data. The loss calculation unit 112 may calculate a loss by using a loss function in which a correct answer vector and a feature amount vector are taken as inputs when the target data are data having a specific statistical property, and may calculate a loss by using a loss function in which a class classification inference result and class label information are taken as inputs when the target data are data having a statistical property other than the specific statistical property.

The loss calculation unit 112 may further calculate a gradient of the loss function with respect to the weight vector of each class of the class classifier 111. The parameter correction amount calculation unit may calculate a correction amount of the weight vector of the class classifier 111 by statistical processing using the gradient of the loss function with respect to the weight vector of each class of the class classifier 111 and statistical property information.

The loss calculation unit 112 may further calculate the gradient of the loss function with respect to the parameter of the feature amount extractor 110. In addition, the parameter correction amount calculation unit may use the gradient of the loss function with respect to the parameter of the feature amount extractor 110 as the correction amount of the parameter of the feature amount extractor 110, or may calculate a correction amount of the parameter of the feature amount extractor 110 by statistical processing using the gradient of the loss function with respect to the parameter of the feature amount extractor 110 and statistical property information.

The learning device 12 may further include a statistical property information estimation unit that estimates statistical property information of the target data. The statistical property information estimation unit is associated to the statistical property information estimation unit 108 according to the third example embodiment described above. The parameter correction amount calculation unit may use input statistical property information when the statistical property information is input to the input unit 109, and may use the statistical property information estimated by the statistical property information estimation unit when there is no input of the statistical property information to the input unit 109.

(Computer Achieving a Learning Device) The learning devices 10, 11, 12, and 13 according to the first, second, third, and fourth example embodiments described above can be achieved by a computer. This computer is composed of a computer system including a personal computer, a word processor, and the like. However, the present invention is not limited to this, and the computer may be configured by a server of a local area network (LAN), a host of computer (personal computer) communication, a computer system connected on the Internet, or the like. It is also possible to distribute the functions among the devices on the network and configure the computer with the entire network.

In the first, second, third, and fourth example embodiments described above, it has been described that the learning devices 10, 11, 12, and 13 according to the present disclosure have hardware configurations, but the present disclosure is not limited thereto. The present disclosure can also be achieved by causing a processor 1010, to be described later, to execute a computer program for performing various processing such as learning data acquisition processing, feature amount extraction processing, class classification processing, loss calculation processing, parameter correction amount calculation processing, parameter correction processing, and parameter determination processing described above.

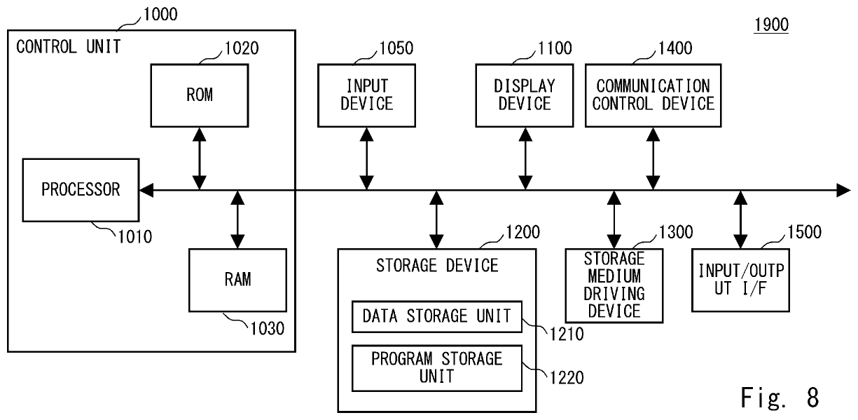

FIG. 8 is a block diagram illustrating an example of a configuration of a computer 1900 for achieving the learning devices 10, 11, 12, and 13 according to the first, second, third, and fourth example embodiments described above. As illustrated in FIG. 8, the computer 1900 includes a control unit 1000 that controls the entire system. An input device 1050, a display device 1100, a storage device 1200, a storage medium driving device 1300, a communication control device 1400, and an input/output I/F 1500 are connected to the control unit 1000 via a bus line such as a data bus.

The control unit 1000 includes a processor 1010, a read only memory (ROM) 1020, and a random access memory (RAM) 1030.

The processor 1010 performs various types of information processing and controls according to programs stored in various storage units such as the ROM 1020 and the storage unit 1200.

The ROM 1020 is a read-only memory in which various programs and data for the processor 1010 to perform various controls and calculations are stored in advance.

The RAM 1030 is a random access memory used as a working memory for the processor 1010. In the RAM 1030, various areas for performing various processing according to the first, second, third, and fourth example embodiments described above can be secured.

The input device 1050 is an input device that receives input from a user such as a keyboard, a mouse, and a touch panel. For example, the keyboard is provided with various keys such as a numeric keypad, function keys for executing various functions, and cursor keys. The mouse is a pointing device, and is an input device that designates an associated function by clicking a key, an icon, or the like displayed on the display device 1100. The touch panel is an input device disposed on a surface of the display device 1100, which specifies a touch position of a user in response to various operation keys displayed on the screen of the display device 1100, and accepts an input of an operation key displayed in response to the touch position.

As the display device 1100, for example, a cathode ray tube (CRT) display, a liquid crystal display, or the like is used. The display device 1100 displays input results from a keyboard and a mouse, and finally displays searched image information. In addition, the display device 1100 displays an image of operation keys for performing various necessary operations from the touch panel according to various functions of the computer 1900.

The storage device 1200 includes a readable/writable storage medium and a driving device for reading/writing various information such as a program and data from/to the storage medium.

Although a hard disk or the like is mainly used as the storage medium used in the storage device 1200, a non-temporary computer-readable medium to be used in a storage medium driving device 1300 that will be described later may be used.

The storage device 1200 includes a data storage unit 1210, a program storage unit 1220, other storage units which are not illustrated (e.g., a storage unit for backing up a program, data, or the like stored in the storage device 1200), and the like. The program storage unit 1220 stores a program for achieving various processing in the first, second, third, and fourth example embodiments described above. The data storage unit 1210 stores various data of various databases according to the first, second, third, and fourth example embodiments described above.

The storage medium driving device 1300 is a driving device for the processor 1010 to read a computer program, data including a document, and the like from an external storage medium.

Herein, the external storage medium refers to a non-transitory computer-readable medium in which a computer program, data, and the like are stored. The non-transitory computer-readable media include various types of tangible storage media. Examples of non-transitory computer-readable media include magnetic recording media (e.g., flexible disks, magnetic tape, hard disk drives), magneto-optical recording media (e.g., magneto-optical disks), compact disc-ROMs (CD-ROMs), CD-Recordables (CD-Rs), CD-Rewritables (CD-R/Ws), and semiconductor memories (e.g., mask ROMs, Programmable ROMs (PROMs), Erasable PROMs (EPROMs), flash ROMs, and RAMs). The various programs may also be supplied to a computer by various types of transitory computer-readable media. Examples of the transitory computer-readable media include electrical signals, optical signals, and electromagnetic waves. The temporary computer-readable medium can supply various programs to a computer via a wired communication path such as an electric wire and an optical fiber, or a wireless communication path and the storage medium driving device 1300.

In other words, in the computer 1900, the processor 1010 of the control unit 1000 reads various programs from an external storage medium set in the storage medium driving device 1300, and stores the programs in each unit of the storage device 1200.

When the computer 1900 executes various processing, the computer 1900 reads a relevant program from the storage device 1200 into the RAM 1030 and executes the program. However, the computer 1900 can also read and execute a program directly from an external storage medium into the RAM 1030 by the storage medium driving device 1300 instead of from the storage device 1200. Depending on the computer, various programs and the like may be stored in the ROM 1020 in advance and executed by the processor 1010. Further, the computer 1900 may download and execute various programs and data from another storage medium via the communication control device 1400.

The communication control device 1400 is a control device for network connection between the computer 1900 and various external electronic devices such as another personal computer and a word processor. The communication control device 1400 makes it possible to access the computer 1900 from these various external electronic devices.

The input/output I/F 1500 is an interface for connecting various input/output devices via a parallel port, a serial port, a keyboard port, a mouse port, and the like.

The processor 1010 may use a central processing unit (CPU), a graphics processing unit (GPU), a field-programmable gate array (FPGA), a digital signal processor (DSP), an application specific integrated circuit (ASIC), or the like.

The order of execution of each processing in the systems and methods described in the claims, description, and drawings is not expressly referred to as “prior to”, “before,”, or the like, and may be implemented in any order unless the output of the preceding processing is used in subsequent processing. In the operation flow in the claims, the description, and the drawings, even when the description is made by using “first”, “next”, or the like for convenience, it is not meant to be indispensable to carry out the operations in this order.

Although this disclosure has been described above with reference to the example embodiments, this disclosure is not limited to the example embodiments described above. Various modifications may be made to the structures and details of this disclosure as will be understood by those skilled in the art within the scope of this disclosure.

### INDUSTRIAL APPLICABILITY

This disclosure is applicable to a variety of data, including image processing such as face recognition and object recognition. In particular, the present disclosure can be used in an image processing device for improving recognition performance in a near-infrared image, a far-infrared image, or the like without degrading recognition performance in a visible light image.

### REFERENCE SIGNS LIST

10, 11, 12, 13 Learning device
100 Data input unit
101, 110 Feature amount extractor
102, 111 Class classifier
103 Correct answer information input unit
104 Statistical property information input unit
105, 112 Loss calculation unit
106 Parameter correction amount calculation unit
107, 113 Parameter correction unit
108 Statistical property information estimation unit
109 Input unit
1000 Control unit
1010 Processor
1020 ROM
1030 RAM
1050 Input device
1100 Display device
1200 Storage device
1210 Data storage unit
1220 Program storage unit
1300 Storage medium driving device
1400 Communication control device
1500 Input/output I/F
1900 Computer

What is claimed is:

1. A learning device configured to perform supervised learning of a class classification problem, the learning device comprising:
at least one memory configured to store instructions; and
at least one processor configured to execute the instructions to:
input target data to be learned, class label information of the target data, and statistical property information of the target data;
extract, by a feature amount extractor, a feature amount from the target data by using a parameter;
output, by a class classifier, a class classification inference result of the target data by statistical processing using the feature amount and a weight vector of each class;
calculate a loss by using a loss function in which the class classification inference result and the class label information are taken as inputs; and
correct the weight vector of the class classifier and the parameter of the feature amount extractor in such a way that the loss is reduced, according to the statistical property information.

2. The learning device according to claim 1, wherein the at least one processor configured to execute the instructions to:
calculate a correction amount of the weight vector of the class classifier and a correction amount of the parameter of the feature amount extractor in such a way that the loss is reduced, according to the statistical property information; and
correct the weight vector of the class classifier and the parameter of the feature amount extractor by using the calculated correction amount.

3. The learning device according to claim 2, wherein the at least one processor configured to execute the instructions to:
input a correct answer vector of the target data when the target data are data having a specific statistical property, and input the class label information of the target data when the target data are data having a statistical property other than the specific statistical property,
extract a feature amount vector from the target data as the feature amount, and
calculate the loss by using a loss function in which the correct answer vector and the feature amount vector are taken as inputs when the target data are data having the specific statistical property, and calculate the loss by using a loss function in which the class classification inference result and the class label information are taken as inputs when the target data are data having a statistical property other than the specific statistical property.

4. The learning device according to claim 2, wherein the at least one processor configured to execute the instructions to:
calculate a gradient of the loss function with respect to the weight vector of each class of the class classifier, and
calculate a correction amount of the weight vector of the class classifier by statistical processing using a gradient of the loss function with respect to the weight vector of each class of the class classifier, and the statistical property information.

5. The learning device according to claim 4, wherein the at least one processor configured to execute the instructions to:
calculate a gradient of the loss function with respect to the parameter of the feature amount extractor, and
use a gradient of the loss function with respect to the parameter of the feature amount extractor as a correction amount of the parameter of the feature amount extractor, or calculate a correction amount of the parameter of the feature amount extractor by statistical processing using a gradient of the loss function with respect to the parameter of the feature amount extractor, and the statistical property information.

6. The learning device according to claim 2, wherein the at least one processor configured to execute the instructions to:
estimate the statistical property information of the target data, and
use, when the statistical property information is input, the input statistical property information, and uses, when there is no input of the statistical property information unit, the estimated statistical property information unit.

7. A learning method by a learning device configured to performs supervised learning of a class classification problem, the learning method comprising:
inputting target data to be learned, class label information of the target data, and statistical property information of the target data;
extracting, by a feature amount extractor, a feature amount from the target data by using a parameter;
outputting, by a class classifier, a class classification inference result of the target data by statistical processing using the feature amount and a weight vector of each class;
calculating a loss by using a loss function in which the class classification inference result and the class label information are taken as inputs; and
correcting the weight vector of the class classifier and the parameter of the feature amount extractor in such a way that the loss is reduced, according to the statistical property information.

8. A non-transitory computer-readable medium storing a program causing a computer that performs supervised learning of a class classification problem to execute:
processing of inputting target data to be learned, class label information of the target data, and statistical property information of the target data;
processing of extracting, by a feature amount extractor, a feature amount from the target data by using a parameter;
processing of outputting, by a class classifier, a class classification inference result of the target data by statistical processing using the feature amount and a weight vector of each class;
processing of calculating a loss by using a loss function in which the class classification inference result and the class label information are taken as inputs; and
processing of correcting the weight vector of the class classifier and the parameter of the feature amount extractor in such a way that the loss is reduced, according to the statistical property information.
